(19) United States
(12) Patent Application Publication
(10) Pub. No.: US 2019/0111587 A1
(43) Pub. Date: Apr. 18, 2019

(54) INJECTION MOLDING EQUIPMENT

(71) Applicant: SHING FUH TAI TECHNOLOGY CORP., Tainan City (TW)

(72) Inventors: Chia-Miao CHIU, Tainan City (TW); Kuo-Ming CHEN, Tainan City (TW); Kuong-Lam IP, Tainan City (TW)

(21) Appl. No.: 15/786,333

(22) Filed: Oct. 17, 2017

(51) Int. Cl. B29C 31/04; B29C 47/84; B29C 45/00

(52) U.S. Cl. CPC B29C 31/04; B29C 2045/1875; B29C 45/0025; B29C 47/842

(57) ABSTRACT

An injection molding equipment includes an injection molding machine, and a feeding machine mounted on the injection molding machine and configured to feed plastic granules into the same. The injection molding machine includes an injection device having an inner horizontal tubular surface that defines a horizontal channel and an inner vertical tubular surface that defines a vertical channel, and an extruder screw rotatably disposed in the horizontal channel and configured to heat and propel the plastic granules. The feeding machine includes a supply tube inserted into the vertical channel for supplying the plastic granules into the horizontal channel.

### FIELD

The disclosure relates to a polymer/plastic processing equipment, more particularly to an injection molding equipment.

### BACKGROUND

Referring to FIGS. 1 and 2, a conventional injection molding equipment includes a machine body 11, a material tube 12 disposed on the machine body 11 and extending horizontally, a funnel 13 disposed on and communicating with the material tube 12, and an extruder screw 14 inserted into the material tube 12. The extruder screw 14 is rotatable about its own axis, and is heated to melt plastic granules in an interior of the material tube 12. The funnel 13 receives a certain amount of the plastic granules, and has a material exit opening 131 communicating with the material tube 12 for continuous supply of the plastic granules into the same.

When the plastic granules pass through the material exit opening 131, they are easily and cooperatively pressed and squeezed by a wall 121 of the material tube 12, a wall 132 of the funnel 13 defining the material exit opening 131 and a blade 141 of the extruder screw 14 so as to crush and break into granule fragments 15 that adhere to the blade 141. Because the contact of the granule fragments 15 with the blade 141 is long, the granule fragments are easily burnt and turn black due to excessive heating. As a result, a finished product produced by the conventional injection molding equipment has black spot defective portions.

### SUMMARY

Therefore, an object of the present disclosure is to provide an improved injection molding equipment.

Accordingly, an injection molding equipment of this disclosure comprises an injection molding machine and a feeding machine. The injection molding machine includes an injection device having an inner horizontal tubular surface that defines a horizontal channel and an inner vertical tubular surface that extends upwardly from the inner horizontal tubular surface and that defines a vertical channel communicating with the horizontal channel, and an extruder screw rotatably disposed in the horizontal channel and configured to heat and propel the plastic granules. The feeding machine is mounted on the injection molding machine and is configured to feed plastic granules into the injection molding machine. The feeding machine includes a supply tube inserted into the vertical channel for supplying the plastic granules into the horizontal channel. The supply tube is spaced apart from the inner vertical tubular surface in an in-out direction, and has a bottom end portion spaced apart from the extruder screw in a top-bottom direction.

### BRIEF DESCRIPTION OF THE DRAWINGS

Other features and advantages of the disclosure will become apparent in the following detailed description of the embodiment with reference to the accompanying drawings, of which:

FIG. 1 is a partly sectional view of a conventional injection molding equipment;

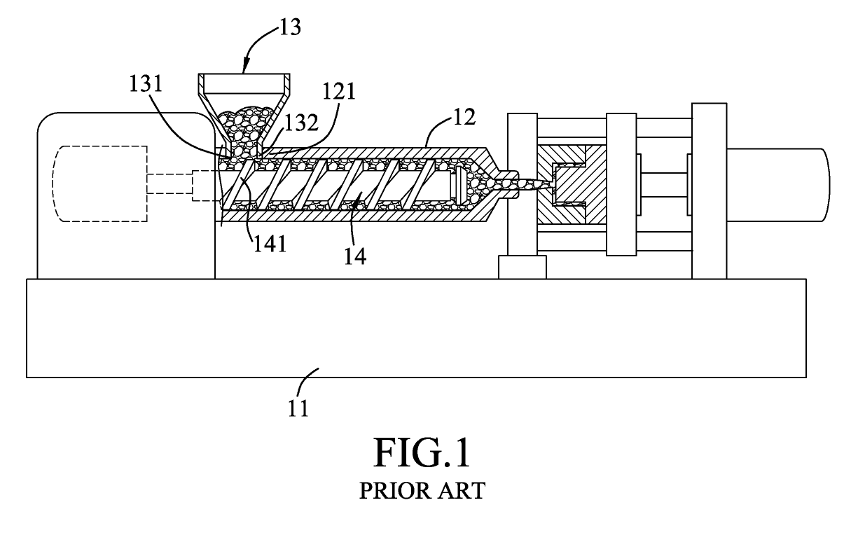

FIG. 2 is an enlarged fragmentary sectional view of the conventional injection molding equipment;

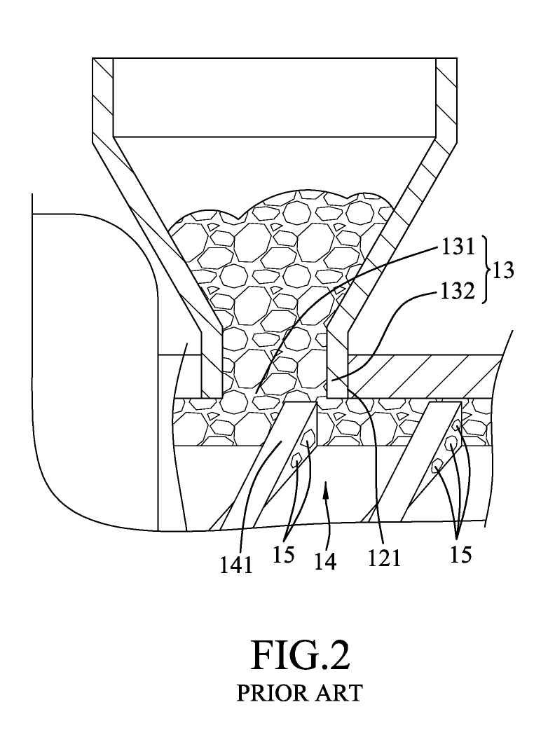

FIG. 3 is a sectional view of an injection molding equipment according to the embodiment of the present disclosure;

FIG. 4 is a sectional view of the embodiment taken from another angle;

FIG. 5 is an enlarged fragmentary sectional view of FIG. 3, illustrating a supply tube formed with a first suction hole and a plurality of second suction holes;

FIG. 6 is a view similar to FIG. 3, but illustrating the embodiment in a state of use;

FIG. 7 is a view similar to FIG. 4, but illustrating the embodiment in a state of use; and

FIG. 8 is a view similar to FIG. 5, but with the presence of plastic granules in a material supply area of a switching seat and the supply tube.

### DETAILED DESCRIPTION

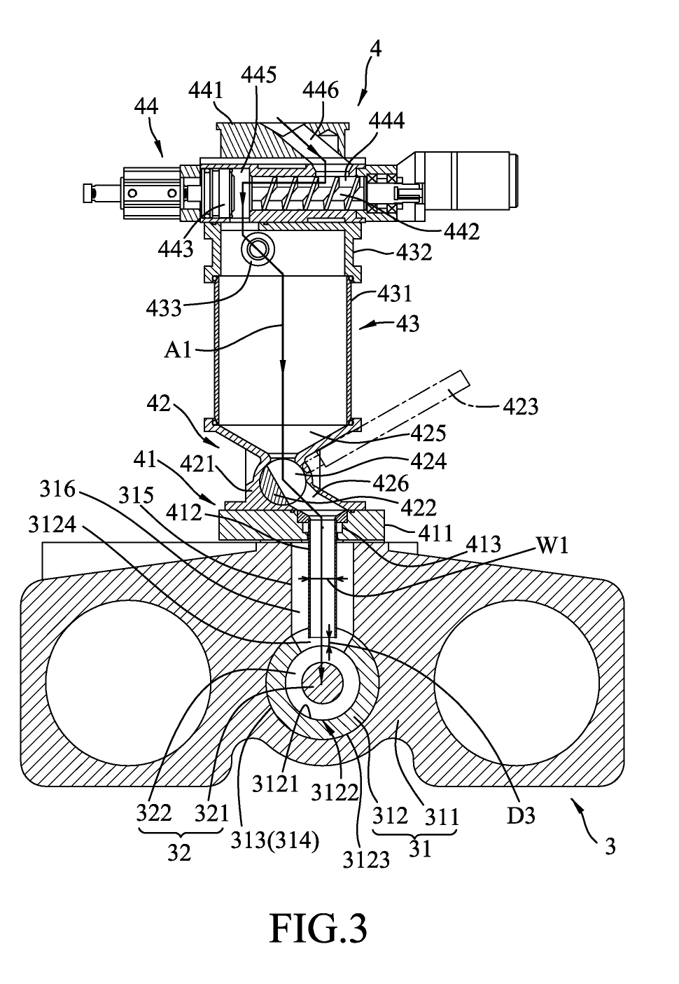

Referring to FIGS. 3 to 5, an injection molding equipment according to the embodiment of the present disclosure is shown to comprise an injection molding machine 3 and a feeding machine 4.

The injection molding machine 3 includes an injection device 31 and an extruder screw 32. The injection device 31 includes an injection seat 311 and a tubular sleeve 312. The injection seat 311 has an inner horizontal tubular surface 313 that defines a horizontal channel 314, and an inner vertical tubular surface 315 extending upwardly from the inner horizontal tubular surface 313 and defining a vertical channel 316 that communicates with the horizontal channel 314. The vertical channel 316 has a uniform width.

The tubular sleeve 312 is inserted into the horizontal channel 314, and has an inner horizontal tubular surface 3121 defining a horizontal channel 3122, an outer horizontal tubular surface 3123 opposite to the inner horizontal tubular surface 3121 and abutting against the inner horizontal tubular surface 313 of the injection seat 311, and a through hole 3124 that extends transversely through the inner and outer horizontal tubular surfaces 3121, 3123, that tapers from the outer horizontal tubular surface 3123 to the inner horizontal tubular surface 3121, that is located below and aligned with the vertical channel 316 and that intercommunicates the horizontal channel 3122 and the vertical channel 316. The through hole 3124 has a smallest diameter (D1).

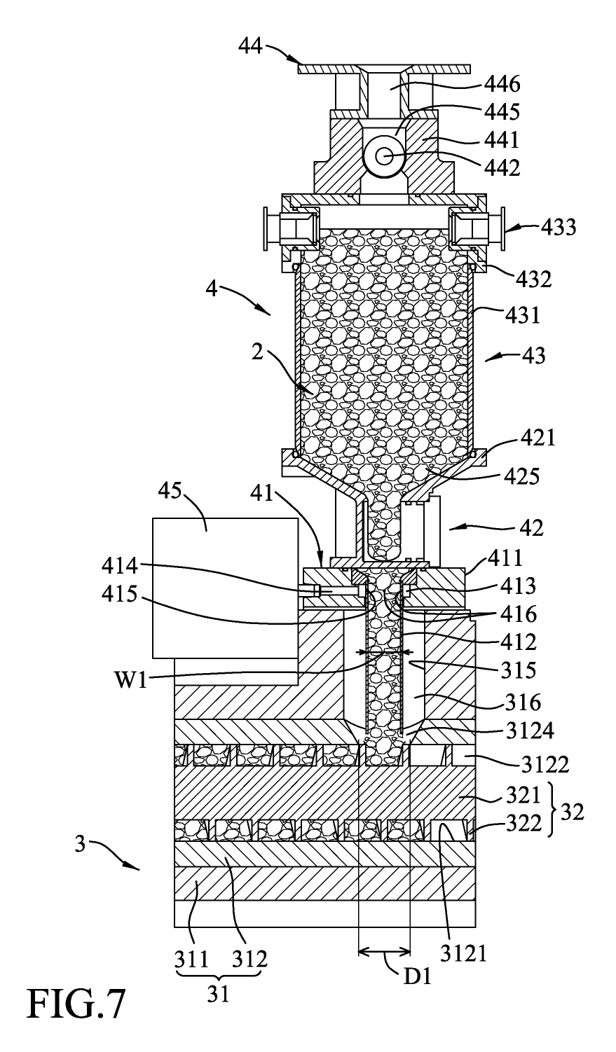

In this embodiment, the extruder screw 32 is rotatably disposed in the horizontal channel 3122 of the tubular sleeve 312. The extruder screw 32 has a shank 321 rotatable about its own axis, and a blade 322 extending helically around the shank 321. The shank 321 and the blade 322 can cooperatively heat and melt a plurality of plastic granules 2 (see FIG. 7) supplied into the horizontal channel 3122, and propel the plastic melt into a mold (not shown) disposed externally of the extruder screw 32 for forming into a finished product.

The feeding machine 4 includes a material supply device 41 disposed on the injection seat 311, a switching device 42 connected to a top portion of the material supply device 41, a storage device 43 connected to a top portion of the switching device 42, a feeding device 44 connected to a top portion of the storage device 43, an air suction device 45 connected to one side of the material supply device 41, and a control device (not shown) in signal connection with the feeding device 44 and the storage device 43.

The material supply device 41 includes a material supply seat 411 disposed on top of the injection seat 311, and a supply tube 412 connected to the material supply seat 411. The material supply seat 411 is formed with a material supply passage 413 that extends vertically therethrough and that communicates with the vertical channel 316, and an air suction passage 414 extending horizontally and transverse to the material supply passage 413. The material supply passage 413 tapers in multiple stages in a top-to-bottom direction.

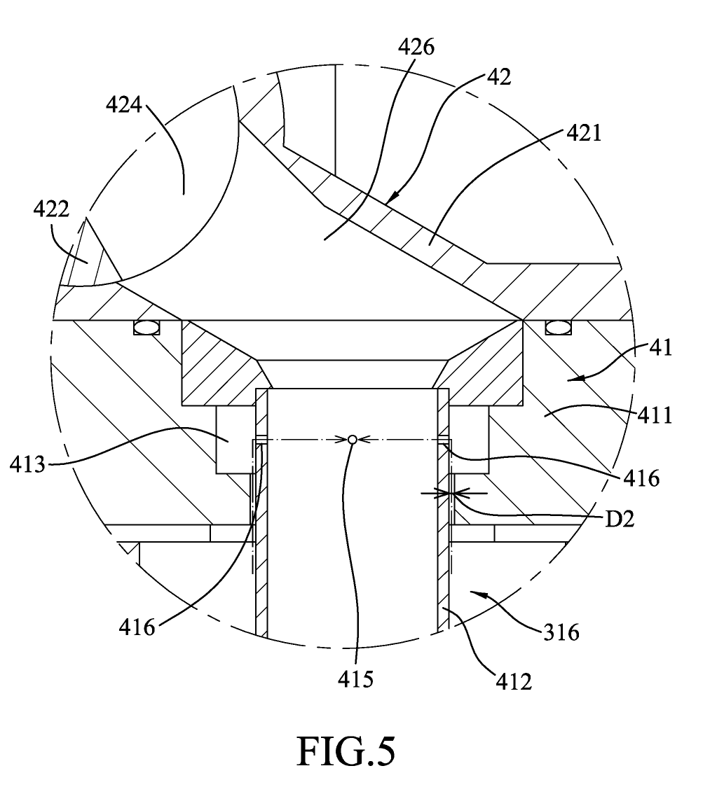

The supply tube 412 is a circular tube having an outer diameter (W1) that is slightly smaller than a smallest width of the material supply passage 413 to thereby leave a gap (D2) of 0.5 to 1 mm therebetween and that is smaller than the smallest diameter (D1) of the through hole 3124. The supply tube 412 has a top end portion inserted into the material supply passage 413 and positioned thereat, a bottom end portion located in the through hole 3124, and an intermediate portion between the top and bottom end portions and located in the vertical channel 316. The supply tube 412 is spaced apart from the vertical tubular surface 315 in an in-out direction. The bottom end portion of the supply tube 412 is spaced apart from the blade 322 in a top-bottom direction by a distance (D3) of 5 to 10 mm. The top end portion of the supply tube 412 is formed with a first suction hole 415 communicating with the air suction passage 414, and three second suction holes 416 angularly spaced apart from each other and from the first air suction hole 415. The second air suction holes 416 communicate with the vertical channel 316 through the gap (D2), as shown in FIG. 5. In other embodiment, the supply tube 412 may not be a circular tube.

The switching device 42 includes a switching seat 421, a switching valve 422 disposed on the switching seat 421, and a switching handle 423 connected to the switching valve 422 and extending out of the switching seat 421. The switching seat 421 has a switching area 424 located at the center thereof and having a circular vertical cross section, a communication area 425 located above the switching area 424 and tapering in the top-to-bottom direction, and a material supply area 426 extending downwardly and obliquely from the switching area 424. The communication area 425 has a lower end communicating with the switching area 424. The material supply area 426 has an upper end communicating with the switching area 424, and a lower end communicating with the material supply passage 413. The switching valve 422 is rotatable about the center of the switching area 424 to open or close the lower end of the communication area 425 and the upper end of the material supply area 426. The switching handle 423 is operable by a user to rotate the switching valve 422.

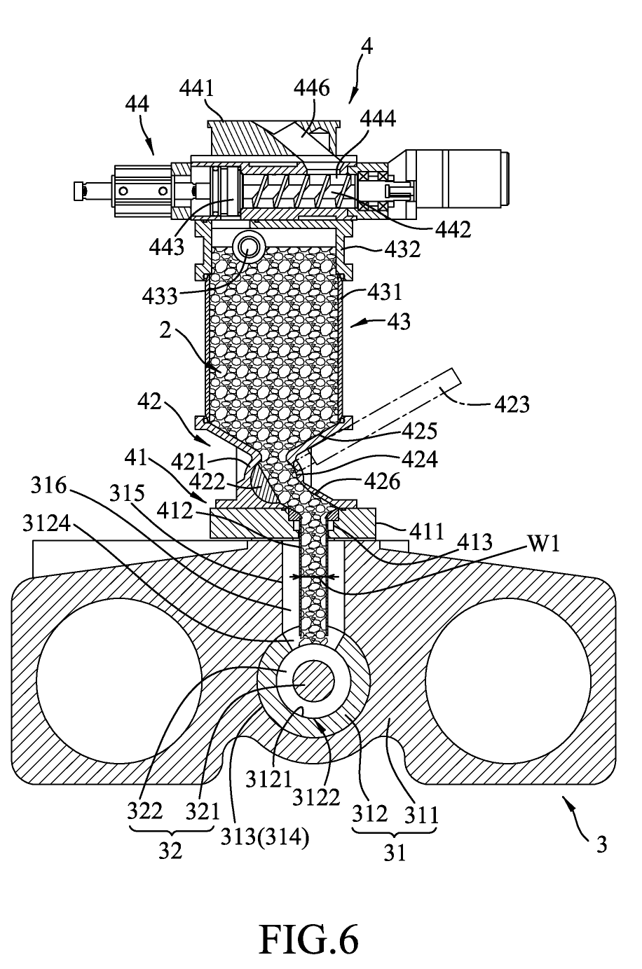

The storage device 43 includes a storage container 431 disposed on the switching seat 421 for receiving the plastic granules 2 (see FIG. 6) and having a lower end communicating with the communication area 425, a hollow storage seat 432 disposed on top of the storage container 431 and having a circular horizontal cross section, and a detection element 433 disposed on the storage seat 432 for detecting the filling amount of the plastic granules 2 in the storage container 431.

The feeding device 44 includes a feeding seat 441 disposed on top of the storage seat 432, and a threaded rod 442 and a feeding valve 443 both disposed in the feeding seat 441. The feeding seat 441 has a threaded rod area 444 for receiving the threaded rod 442, a feeding valve area 445 having a right end communicating with the threaded rod area 444 and a bottom end communicating with the storage seat 432, and a feeding area 446 extending obliquely from a top end thereof and having a top end communicating with the outside environment and a bottom end communicating with a right top end of the threaded rod area 444. The threaded rod 442 is used for pushing the plastic granules 2. The feeding valve 443 is movable leftward and rightward in the feeding valve area 445 for opening or closing the bottom end and the right end of the feeding valve area 445.

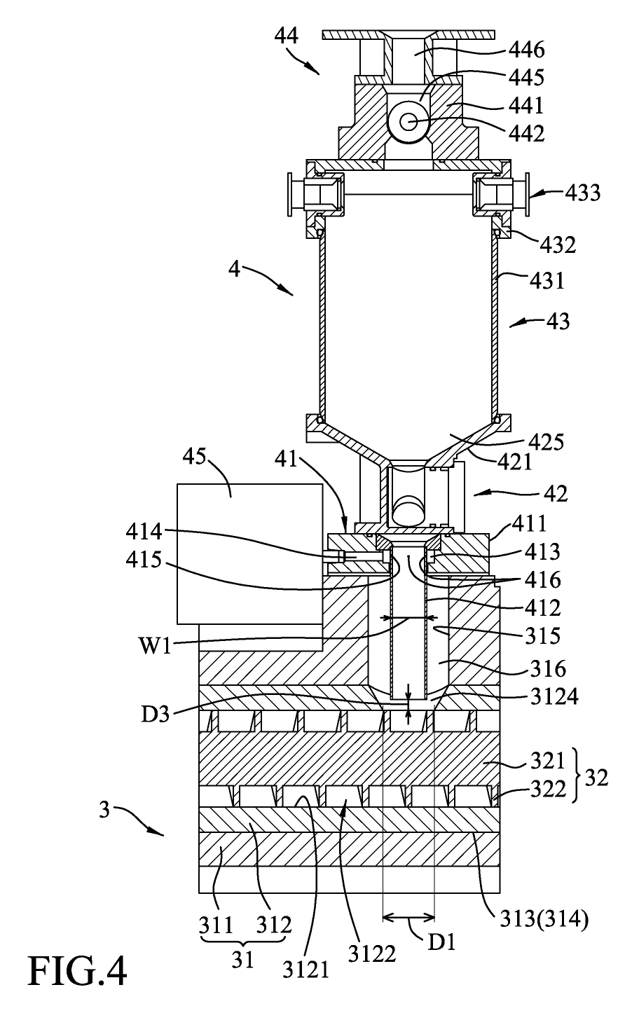

The air suction device 45, as shown in FIG. 4, is connected to the air suction passage 414 for sucking air out of the material supply passage 413, the vertical channel 316, the horizontal channel 3122, the supply tube 412, the switching device 42 and the storage device 43. The control device can control the threaded rod 442 and the feeding valve 443 according to a signal transmitted by the detection element 433.

In use, the plastic granules 2 are poured into the feeding device 44 through the feeding area 446, fall into the threaded rod 442, and are pushed by the threaded rod 442 from the threaded rod area 444 to the feeding valve area 445. The plastic granules 2 then fall from the bottom end of the feeding valve area 445 into the storage container 431, and from the storage container 431 to the communication area 425, the switching area 424 and the material supply area 426. Finally, the plastic granules 2 fall from the material supply area 426 into the horizontal channel 3122 through the material supply passage 413 and the supply tube 412, as indicated by the arrows (A1) in FIG. 3. During continuous rotation of the blade 322 of the extruder screw 32 to propel the plastic granules 2, because the supply tube 412 and the extruder screw 32 are spaced apart in the top-bottom direction, the extruder screw 32 is not likely to cooperate with the supply tube 412 to squeeze therebetween the plastic granules 2, so that crushing of the plastic granules into fragments can be prevented. Thus, the problem encountered by the conventional injection molding equipment regarding the adhesion of the fragments of the plastic granules to the blade and being burnt and turning black due to excessive heating resulting in a finished product having black spot defective portions can be resolved. Further, the plastic granules 2 can spread out after leaving the supply tube 412, so that a force from upper ones of the plastic granules 2 pressing lower ones of the plastic granules 2 against the blade 322 can be reduced. The effect of preventing the plastic granules 2 from being crushed can be similarly achieved.

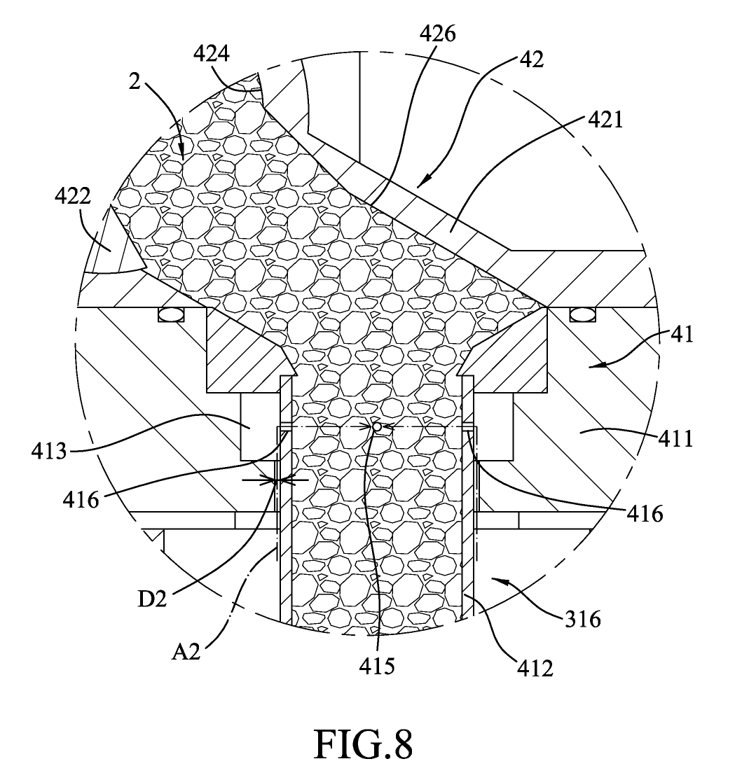

Referring to FIGS. 6 to 8, as the plastic granules 2 are continuously fed into the feeding area 446, they are gradually stacked in the storage container 431 until the stacked height corresponds to the position of the detection element 433. At this time, the detection element 433 will send a signal to the control device, which in turn, will stop the operation of the threaded rod 442 and drive the feeding valve 443 to move to a position that closes the bottom end and the right end of the feeding valve area 445. Further, the air suction device 45 is operated to suck air out of the material supply passage 413, the supply tube 412, the vertical channel 316, the horizontal channel 3122, interiors of the storage container 431 and the storage seat 432, and the feeding valve area 445 through the air suction passage 414. The plastic granules 2 are heated in the horizontal channel 3122 by the extruder screw 32 so as to melt, and the absorbed moisture or the contained non-volatile organic solvent thereof is also heated and transformed into gas. The gas is sucked out by the air suction device 45 through the supply tube 412 or through a space between the supply tube 412 and the vertical tubular surface 315 and then through the gap (D2) between the supply tube 412 and the material supply passage 413, as shown by the arrow (A2) in FIG. 8. Hence, a finished product made from this embodiment will have no holes caused by the gas, so that the mechanical properties and the appearance of the finished product are enhanced. Moreover, water vapor can be sucked out through the space between the supply tube 412 and the vertical tubular surface 315 and the gap (D2) to prevent the gas from contacting and affecting the plastic granules 2 in the supply tube 412 during air suctioning.

In other embodiment of this disclosure, the tubular sleeve 312 may be dispensed with. In this case, the extruder screw 32 is rotatably disposed in the horizontal channel 314 of the injection seat 311, as long as the supply tube 412 is spaced apart from the extruder screw 32 and the vertical tubular surface 315, any configuration of the injection seat 311 is acceptable. Further, the plastic granules 2 fall from the vertical channel 316 into the horizontal channel 314 to be heated and propelled by the extruder screw 2, and the air suction device 45 is configured to suck air out of the material supply passage 413, the supply tube 412, the vertical channel 316, the horizontal channel 314, the interiors of the storage container 431 and the storage seat 432, and the feeding valve area 445 through the air suction passage 414 during the operation thereof.

In sum, the advantage of the injection molding equipment of this disclosure resides in that, through the configuration of the supply tube 412 which is spaced apart from the extruder screw 32 and the vertical tubular surface 315, the plastic granules 2 is provided with a large activity space so that the plastic granules 2 can be prevented from being squeezed and crushed into fragments. Through this, the finished product made from this disclosure has no black spot defective portions, and the product yield can be enhanced.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An injection molding equipment comprising:
an injection molding machine including an injection device having an inner horizontal tubular surface that defines a horizontal channel and an inner vertical tubular surface that extends upwardly from said inner horizontal tubular surface and that defines a vertical channel communicating with said horizontal channel, and an extruder screw rotatably disposed in said horizontal channel and configured to heat and propel the plastic granules; and
a feeding machine mounted on said injection molding machine and configured to feed plastic granules into said injection molding machine, said feeding machine including a supply tube inserted into said vertical channel for supplying the plastic granules into said horizontal channel, said supply tube being spaced apart from said inner vertical tubular surface in an in-out direction, and having a bottom end portion spaced apart from said extruder screw in a top-bottom direction.

2. The injection molding equipment as claimed in claim 1, wherein said injection device includes an injection seat having said inner horizontal tubular surface and said inner vertical tubular surfaces, and a tubular sleeve inserted into said horizontal channel between said inner horizontal tubular surface and said extruder screw, said tubular sleeve having an inner horizontal tubular surface that defines a horizontal channel, an outer horizontal tubular surface opposite to said inner horizontal tubular surface and abutting against said inner horizontal tubular surface of said injection seat, and a through hole that extends transversely through said inner and outer horizontal tubular surfaces of said tubular sleeve, that is aligned with said vertical channel and that intercommunicates said horizontal channel of said tubular sleeve and said vertical channel, said extruder screw being rotatably received in said horizontal channel of said tubular sleeve.

3. The injection molding equipment as claimed in claim 2, wherein said vertical channel has a uniform width, said through hole being located below said vertical channel and being tapered from said inner horizontal tubular surface to said outer horizontal tubular surface of said tubular sleeve, said bottom end portion of said supply tube being located in said through hole.

4. The injection molding equipment as claimed in claim 3, wherein said supply tube has an outer diameter smaller than a smallest diameter of said through hole.

5. The injection molding equipment as claimed in claim 1, wherein said bottom end portion of said supply tube is spaced apart from said extruder screw by a distance of 5 to 10 mm.

6. The injection molding equipment as claimed in claim 1, wherein said feeding machine further includes an air suction device configured to suck air out of said supply tube, said vertical channel and said horizontal channel of said injection device.

7. The injection molding equipment as claimed in claim 6, wherein said supply tube is formed with a first suction hole communicating with said air suction device, and at least one second suction hole communicating with said vertical channel.

8. The injection molding equipment as claimed in claim 2, wherein said feeding machine further includes an air suction device configured to suck air out of said supply tube, said vertical channel, and said horizontal channel of said tubular sleeve.

9. The injection molding equipment as claimed in claim 8, wherein said supply tube is formed with a first suction hole communicating with said air suction device, and at least one second suction hole communicating with said vertical channel.
